(19) United States
(12) Patent Application Publication
(10) Pub. No.: US 2005/0198262 A1
(43) Pub. Date: Sep. 8, 2005

(54) Method and system for measuring remote-access VPN quality of service

(76) Inventors: Jon Barry, Odessa, FL (US); Johannes Gutter, Palm Harbor, FL (US); Peter A. Heimann, Clifton, NJ (US); John R. Jensen, Cambridge, MA (US); Ronald Carl Schwabol, Tampa, FL (US); Maria Czarina Spieler, Tampa, FL (US); Christopher Justin Wu, Tampa, FL (US)

Correspondence Address: Mr. S.H. Dworetsky;AT&T Corp., PO Box 4110, Middletown, NJ, 07748, US

(21) Appl. No.: 10/757,297

(22) Filed: Jan. 14, 2004

(51) Int. Cl. G06F 15/173; G06F 15/16

(52) U.S. Cl. 709/224; 709/228

(57) ABSTRACT

A method and apparatus for providing quality of service (QoS) measurements for remote-access users of a virtual private network (VPN) utilizes hardware/software at the remote VPN client to collect information related to the remote client's ability to connect to the VPN and remain connected. A centralized server is configured to query each remote client and upload the collected connection data, the server functioning to analyze the collected data to determine QoS information in terms of, for example, “VPN accessibility” (defined as success rate for connection to VPN servers), “VPN sustainability” (defined as the ability to maintain a network connection), and “VPN availability” (defined as the ability of a persistent remote-access location to maintain its network connect). The QoS measurements allow the VPN service provider to improve the experience of remote access users, generate alarms and reports, and may also be used to form service level agreements (SLAs) with such users.

### TECHNICAL FIELD

The present invention relates to remote-access virtual private networks (VPNs) and, more particularly, to a method and system for utilizing client-side metrics to determine the quality of service (QoS) for remote-access VPN users.

### BACKGROUND OF THE INVENTION

With the advent of high-speed, inexpensive Internet access, virtual private networks (VPNs) have emerged as a popular choice for remote business users that wish to connect their personal computers to internal corporate networks. A virtual private network (VPN) is defined as a private data network that uses a public data network, instead of leased lines, to carry all of the data traffic between various locations of a particular corporation/organization. The most accessible and least expensive public data network currently utilized is the Internet, which can be accessed worldwide with a computer and a modem. An Internet-based VPN is “virtual” because although the Internet is freely accessible to the public, the Internet appears to the organization to be a dedicated private network. In order to accomplish this, the data traffic for the organization should be encrypted at the sender's end and then decrypted at the receiver's end so that other users of the public network can intercept, but not read, the data traffic.

The locations that access this VPN may be broadly classified into two types: dedicated and remote. A dedicated-access location is connected to the VPN via a permanent dedicated circuit to the public network. Telecommunications vendors typically provide such circuits. “Permanent” means that the circuit is always available. “Dedicated” means that the circuit is used only by that individual end-user, so that the transmitted data are secure there. However, the overall data transmission path over the VPN includes the public network, so that encryption is still required to insure end-to-end data security.

A remote-access location is connected to the VPN using an access method that may be shared with other users. In addition, such remote access may be transient, so that the connection is only established when there is an expected need to transmit data. Furthermore, a remote-access location has the ability to establish connections to different VPNs at different times, possibly using different access methods.

One form of remote access to a VPN is via a “plain-old-telephone services” (POTS) dial-up connection to an “Internet service provider” (ISP) that provides the VPN service. For example, a user incorporates an analog modem into a personal computer, or equivalent, and has a customer account with a particular ISP. The user accesses the VPN by simply making a data call to the ISP, e.g., dialing a telephone number associated with the ISP and then logging into the VPN. The remote VPN connection typically requires a software VPN client that is installed on the user's computer and a VPN server that resides on the internal corporate network. The client and server securely transfer the user's data across the public Internet via encryption.

Another typical form of remote access to a VPN is via a broadband connection to an ISP, where a broadband connection includes Digital Subscriber Loop (DSL) service, digital cable service, wireless 802.11 (also referred to in the art as “Wi-Fi”), General Packet Radio Service (GPRS), satellite, etc. In these cases, an appropriate digital modem or similar device is used instead of an analog modem. In some cases, a broadband connection may be “always on”, so that it is not necessary for the user to make a data call in order to transmit data. However, the remote users must still have a software VPN client installed on their computers, and they must still log into the VPN in order to transmit data through the VPN.

For a broadband remote user, there are several types of VPN connections. One type of VPN connection is “on-demand”, which is established whenever the user wishes to transmit data. This connection is kept active based on rules set by the owner of the VPN. For instance, these rules may specify that the VPN connection is closed after a specific total elapsed time (sometimes referred to as “session timeout”), or after there have been no data transmitted for a specific elapsed time (sometimes referred to as “idle timeout”). Another type of VPN connection is a “persistent” connection, which is permanently kept active.

However, any VPN connection, whether through dial-up, broadband, or dedicated access, may be unexpectedly terminated due to problems at any point along the data transmission path. In some cases, these problems can be detected from the VPN server, and this information can be used by the VPN vendor or manager to locate and correct the problem. In other cases, however, the problems can only be detected from the remote-access user location. In such instances, the VPN vendor or manager needs to have access to this type of information in order to locate and correct the problem.

VPNs have become increasingly complicated in order to provide better security across various network configurations. The need for back-up servers and load balancing further complicate the VPN architecture. Most VPN vendors provide tools to monitor and manage their VPN servers. However, these tools do not measure the quality of service (QoS) metrics from the remote user's point of view. For example, connection failures and disconnect reasons may not be apparent from the network's point of view, since the failure/disconnect involves the remote user's VPN client. Understanding the user's experience in remotely connecting to a VPN is becoming increasingly important as businesses are choosing to outsource the management of their remote-access VPNs to professional VPN service providers. Businesses that choose to outsource their VPNs desire guarantees and measurements to audit the quality of their VPN service.

### SUMMARY OF THE INVENTION

The need remaining in the prior art is addressed by the present invention, which relates to remote-access virtual private networks (VPNs) and, more particularly to a method and system for utilizing client-side metrics to determine the quality of service (QoS) for remote-access VPN users.

In accordance with the present invention, intelligent software is included in the VPN client to gather empirical performance data on each session attempt, where this data can then be up-loaded to a centralized server to perform data analysis and generate QoS alarms and reports for the VPN service owner.

In a preferred embodiment, the performance data collected by the client device includes information such as the date and time of each connection attempt, VPN server address, session duration, connection failure reasons (if any) and disconnect reasons. Additional, more detailed information may also be collected, such as the link type, network nodes traversed, IP port, VPN protocol, VPN encryption, etc. Obviously, the greater the detail of the gathered performance data, the more complete the QoS report will be, and the more likely it will be that the network VPN provider can locate and correct problems.

At certain times, typically specified by the VPN provider, these collected client-side metrics are uploaded to a central collection server located in the network. For example, the data from a dial-up user may be uploaded whenever such a user makes a dial connection through an ISP. Alternatively, the data from a broadband “always-on” user may be uploaded at specific times, or at a specific time interval following a previous upload. The data transmission path for the upload of these performance data may be over the VPN, or it may be over the public data network. If the upload is transmitted over the public data network, then these performance data may be encrypted for added security. Such encryption is separate from, and independent of, the encryption of the other “payload” data that are transmitted over the VPN.

Once the performance data are uploaded from the VPN clients, the server will filter, normalize and store the information. Various heuristic algorithms may then be used to analyze the data and generate a report defining the “health” of the VPN with respect to remote-access users. For example, the performance data may be quantified as “VPN accessibility”, defined as the success rate for connecting to VPN servers, “VPN sustainability”, defined as the ability to maintain a VPN connection, and “VPN availability”, defined as the ability to maintain a persistent VPN connection. Other measures of service quality may be used, and can be defined and determined by the VPN service provider. “Fixes” to virtual private network devices and connections may then be made in response to the generated alarms and reports.

Critical to this analysis is the ability to categorize VPN failures. Failures should be classified as a problem of: (1) the network provider; (2) the end-user; or (3) a third party. To classify problems, lines of demarcation must be logically placed along the path traversed by the VPN across the network. For example, the network provider may own, manage, and be responsible for problems with the dial access point, the dial access point's permanent Internet connection, the VPN server, and the VPN server's permanent Internet connection. However, the network provider may not be responsible for errors with the remote user's modem or errors occurring in a portion of the Internet managed by a third-party provider. Client-side and server-side metrics must be combined to accurately classify VPN failures.

Furthermore, additional information can be derived from client-side information when viewed in aggregate. Some individual VPN failures cannot be definitively classified; especially when one or more network nodes traversed by the VPN cannot be identified. However, these failures can be classified when concurrent VPN connections from other clients, to the same VPN server at the time of a failure, are analyzed. The accuracy of these types of “aggregate” analysis is subject to statistical sample-size probability. The specific terms and acceptable margins of error should be formally specified in a Service Level Agreement (SLA) when necessary.

One advantage of the present invention is that, in addition to using these data to locate and correct data transmission problems, the collected performance data may be used as the framework for a Service Level Agreement (SLA) between a VPN service provider and remote-access users.

Other and further advantages and benefits of the present invention will become apparent during the course of the following discussion and by reference to the accompanying drawings.

### BRIEF DESCRIPTION OF THE DRAWINGS

Referring to the drawings,

FIG. 1 illustrates an exemplary prior art VPN illustrating the connection between two VPN locations through a public data network, such as the Internet;

FIG. 2 illustrates an exemplary VPN including both a persistent “remote-access” device and a transient “remote-access” device that may utilize the measurement method and system of the present invention;

FIG. 3 illustrates an exemplary VPN including the remote-access performance monitoring arrangement of the present invention, as well as a number of demarcation locations used to isolate failures and identify the “owner” of the problem; and

FIG. 4 illustrates a communication system including a number of various remote-access VPN locations (with a plurality of separate client devices at each location), illustrating the ability of the monitoring system of the present invention to generate and use aggregate performance information.

### DETAILED DESCRIPTION

In order to better understand the workings and results of the quality of service (QoS) measurement system of the present invention, the following discussion will detail the arrangement of an exemplary prior art virtual private network (VPN) that may benefit by the ability to measure a remote-access user's experience in obtaining and maintaining communication with a VPN.

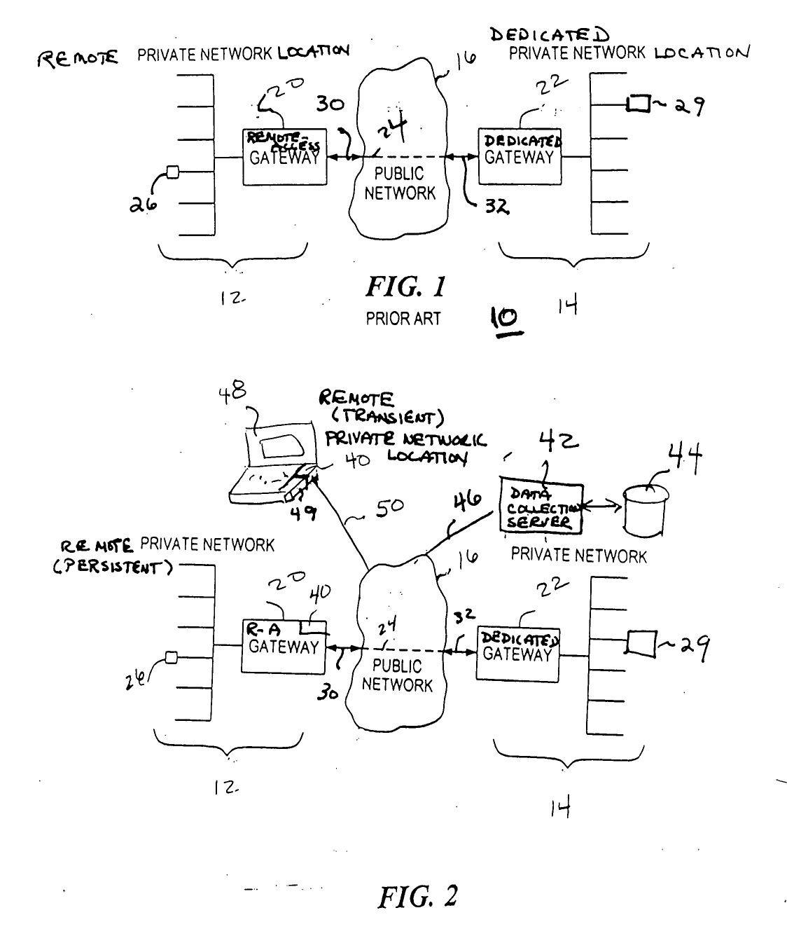

FIG. 1 is a block diagram illustrating a conventional prior art VPN 10. VPN 10 includes a first, remote-access, private network location 12 and a second, dedicated-access, private network location 14, connected together through a public computer network 16, such as the Internet. The communications protocols for first and second VPN locations 12 and 14, as well as Internet 16, may be the standard Internet Protocol (IP). Thus, the communications protocols for the private networks are the same as the public network. Each private network location 12, 14 includes a gateway 20, 22 which interfaces between the respective private network locations and the public network. The connection 30 between remote-access gateway 20 and public data transmission network 16 may be dial-up, broadband, or any other suitable form of remote access, while the connection 32 between dedicated-access gateway 22 and public data transmission network 16 is a suitable form of dedicated access.

Each gateway encrypts data traffic from the private network that is going to enter the public network and decrypts encrypted data received from the public network. In normal operation, a secure communications path 24, referred to as a “tunnel”, is formed through remote-access connection 30, public network 16 and dedicated-access connection 32 to connect gateway 20 and gateway 22. The combination of private network locations 12 and 14 and tunnel 24 through public network 16 forms the virtual private network (VPN). The VPN is defined as “virtual” since it is actually using a public network for the connection, but due to the encryption both private network locations believe that they have a private network over which data may be sent. For example, a node 26 of first, remote-access, private network location 12 may send data which is encrypted by first remote-access gateway 20 through the tunnel 26, and the data is received by second, dedicated-access gateway 22, which decrypts the data and routes it to the appropriate node 29 in second, dedicated-access private network location 14.

This conventional prior art VPN arrangement cannot, however, support the ability to provide quality of service (QoS) measurements of the remote user's connection, as is the case with the teachings of the present invention, as included in the VPN network illustrated in FIG. 2. For the sake of illustration, common elements between the arrangements of FIG. 1 and FIG. 2 are represented by the same reference numerals. As shown in FIG. 2, additional performance software 40 is placed onto the remote access gateway 20 and used to monitor the connection between remote access VPN remote-access location 12 and data transmission network 16. This software provides the capability to collect performance data, and to upload such data to a data collection server 42 coupled to data network 16. This upload is carried over a data path 46, which may be separate from the VPN transmission paths. The gathered performance data are then filtered, normalized and stored in a database 44. The stored data can then be analyzed using specialized analytical queries to generate alarms or reports. In accordance with the terminology discussed above, remote-access location 12 may be defined as a “persistent” remote-access location. That is, the VPN connection is associated with a fixed, permanent location, such as a home office or alternate professional location. In this case, performance software module 40 is located within remote-access gateway 20 so that each “authenticated” individual at that location may access the VPN. As also shown in FIG. 2, remote access to the VPN may utilize a “transient” remote-access communication device, such as personal laptop computer 48. In accordance with the present invention, personal computer 48 includes software module 40 to collect performance data associated with the connection 50 between laptop 48 and data network 16. As with the persistent location 12, the data from transient laptop 48 is uploaded to network 16 via modem 49 and connection 50, and is stored in database 44 for further analysis and action, as necessary.

Regardless of whether the data is collected from a persistent or transient location, the uploaded performance information can be measured in terms such as “VPN accessibility” and “VPN sustainability”. “VPN accessibility” is defined as the success rate for connecting a VPN client to a VPN server, where connection failure reason codes may be used to determine this measurement. “VPN sustainability” is defined as the ability to maintain a VPN connection (using disconnect reason codes to determine this measurement). Further and with respect to a persistent remote-access VPN connection, the performance information denoted as “VPN availability” may be measured, where “VPN availability” is defined as the ability to maintain a persistent remote-access VPN connection (again, disconnect reason codes may be used to determine this measurement).

Other measures of service quality may also be made using the arrangement of the present invention, where additional information may thus generate a more complete QoS report. This information may include items such as link type, the identity of the traversed network nodes, IP port, VPN protocol, VPN encryption type, etc. “Fixes” to virtual private network devices and connections can then be made in response to the generated alarms and reports.

As mentioned above, a significant aspect of the performance analysis system of the present invention is the ability to categorize VPN failures with respect to the “owner” of the problem (i.e., either the network provider, end-user, or other third party communication system provider). For example, the network provider may own, manage, and be responsible for problems with the dial access point, the dial access point's permanent Internet connection, the VPN server and the VPN server's permanent Internet connection. However, the network provider may not be responsible for errors with the remote user's modem, or responsible for errors in portions of the Internet managed by a third party provider.

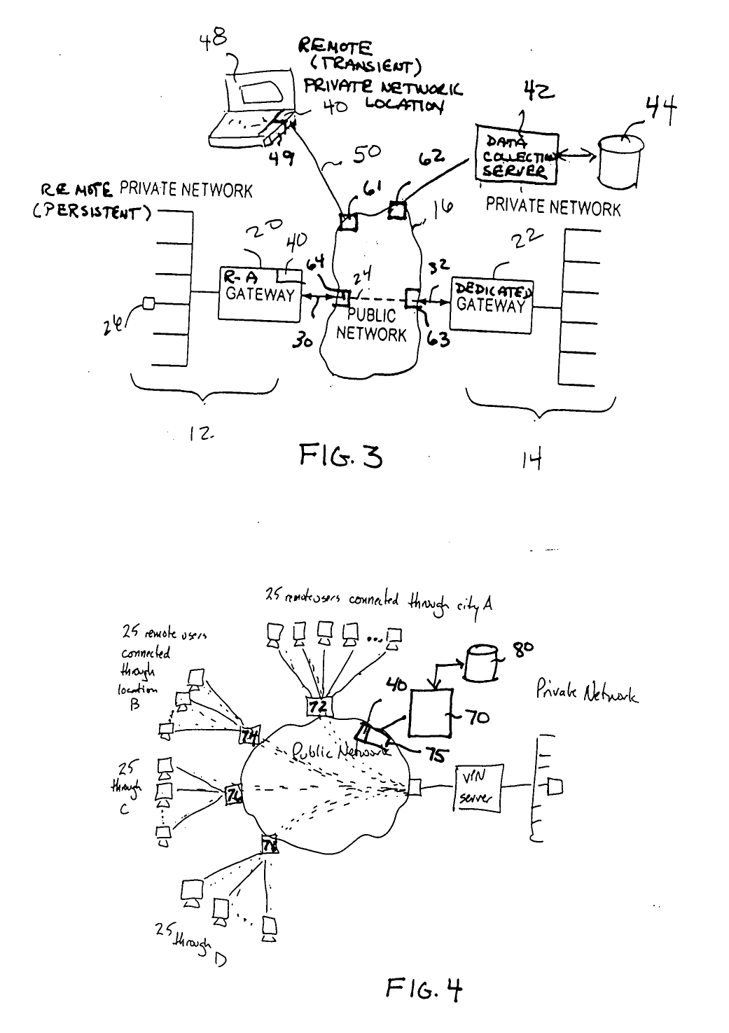

FIG. 3 illustrates a variation of the arrangement of FIG. 2, including a plurality of demarcation points which may be used to isolate the various sources of VPN communication failure between a remote-access user and the dedicated portion of the virtual private network. As shown, problems associated with transmission lines 30, 32 and 50 are owned by the VPN provider, as well as demarcation points 61 and 63. Demarcation point 62 may be used as a reference to isolate a problem which demarcation point 63 is not reachable. Problems associated with modem 49 or laptop 48 are under the control of the user.

As also mentioned above, additional information can be derived from the collected client-side performance information when viewed in aggregate form. Reference is made to FIG. 4, which illustrates a communication system including a VPN data collection server 70 having a connection to a VPN remote-access gateway 75 on the data communication network 16. A set of four dial gateways 72, 74, 76, and 78 in four separate locations, denoted as A-D in FIG. 4, are also disposed on the data communication network 16, where each gateway provides dial access to a plurality of N separate remote-access VPN uses. As shown in FIG. 4, the set of four dial gateways 72, 74, 76 and 78 are also connected to VPN remote-access gateway 75. As with the arrangements described above, VPN remote-access gateway 75 includes performance monitoring software 40, which interacts with each user device through the set of dial gateways 72, 74, 76 and 78. The performance information is uploaded to server 70 and stored in a database 72, which may partition the data into separate records associated with each dial gateway. While the partitions may serve to parse the data by location for individual analysis, it is also an important attribute of the present invention to review the data in aggregate form. For example, if all N clients coupled to dial gateway 72 experiences a failure at the same time, it is likely that the failure occurred within the physical location or at transmission line 73 coupling dial gateway 72 to network 16. However, in only a single client device coupled to dial gateway 72 experiences a failure, the problem is likely to be associated with the user's device (either a hardware or software problem). The accuracy of these types of “aggregate” analysis is subject to statistical sample-size probability. The specific terms and acceptable margins of error should be formally specified in a Service Level Agreement (SLA) when necessary.

While the present invention has been particularly shown and described with reference to a preferred embodiment, it will be understood by those skilled in the art that various changes in form and detail may be made without departing from the spirit and scope thereof.

1. A method of measuring the quality of service provided to a remote-access user of a virtual private network, said virtual private network comprising a plurality of private network locations interconnected through a public data network, with the remote-access user including a VPN client device directly connected to said public data network, the method comprising the steps of:
a) providing measurement software at a VPN client location;
b) collecting, at the VPN client location, VPN performance information;
c) uploading the collected VPN performance information to a centralized server connected between the VPN and said public data network;
d) filtering, normalizing and storing the uploaded VPN performance information at the centralized server;
e) analyzing the stored VPN performance information; and
f) generating a report measuring the quality of service as defined by the analysis of the stored service information.

2. The method as defined in claim 1 wherein the method further comprises the step of performing any required VPN service maintenance actions to correct communication problems included in the generated report.

3. The method as defined in claim 1 wherein step b) comprises the collection of: the date and time of each VPN connection attempt, the identity of the VPN server to which the VPN client is attempting to connect, any connection failure code, and disconnection reason code.

4. The method as defined in claim 1 wherein in step b) comprises the collection of information related to VPN accessibility, VPN sustainability and VPN availability.

5. The method as defined in claim 1 wherein the method is utilized for a plurality of separate remote-access VPN client devices, the steps of analyzing and generating then based on data collected from the plurality of separate remote-access VPN client devices.

6. The method as defined in claim 5 wherein at least one remote-access VPN client device comprises a persistent location VPN client device.

7. The method as defined in claim 5 wherein at least one remote-access VPN client device comprises a transient location VPN client device.

8. The method as defined in claim 5 wherein step f) includes the generation of an aggregate report based on the performance of the plurality of separate remote-access VPN client devices.

9. The method as defined in claim 1 wherein the collecting of step b) further comprises collecting information such as: link type, session duration, IP port identity, type of VPN protocol, type of VPN encryption, identity of network nodes traversed between the VPN client and VPN server.

10. A VPN client node for providing access to a VPN remotely located from a user, the VPN client node comprising
encryption/decryption elements for providing secure communication between the remotely located VPN client and a public data network, said public data network also coupled to said VPN; and
a quality measurement element associated with said VPN client node, said quality measurement element for collecting VPN client performance information and uploading the collected information to a server located in the data communication network.

11. A VPN client node as defined in claim 10 wherein the node is a persistent location, including at least one client user device and a VPN gateway coupling the at least one client node to the data network, wherein the quality measurement element is located at the VPN gateway.

12. A VPN client node as defined in claim 10 wherein the node is a transient, on-demand location with the quality measurement element co-located with the VPN client device.

13. A VPN client node as defined in claim 10 wherein the collected VPN client performance information includes the date and time of each VPN connection attempt by said VPN client node, the identity of the VPN server to which said VPN client node is attempting to connect, any connection failure code, and disconnection reason code.

14. A VPN client node as defined in claim 10 wherein said client node further comprises an upload feature for transmitting the VPN service information collected by the quality measurement element to a centralized server within the VPN.

15. A VPN client node as defined in claim 10 wherein the quality measurement element further collects VPN service information including link type, session duration, IP port identification, type of VPN protocol, type of VPN encryption, identity of network nodes traversed between the VPN client and VPN server.

16. A VPN centralized network server for generating information related to the quality of VPN service experienced by remote-access VPN users, the server comprising:
an arrangement for receiving connect/disconnect information collected by one or more remote-access VPN clients;
a storage means for filtering, normalizing and storing the received data;
an analysis element for reviewing the stored data to determine VPN performance; and
a report generation element, coupled to the analysis element, for providing information regarding the quality of service at one or more remote-access VPN clients.

17. A VPN centralized network server as defined in claim 16 wherein the analysis element reviews performance information, for each remote-access VPN user, including VPN accessibility, VPN sustainability and VPN availability, where VPN accessibility is defined as the ability to connect to a VPN, VPN sustainability is defined as the ability to maintain a connection, and VPN availability is defined as the ability of a persistent remote-access VPN location to maintain a persistent connection.

18. A VPN centralized network server as defined in claim 16 wherein the server is capable of receiving connect/disconnect information from a plurality of separately located remote-access VPN client devices.

19. A VPN centralized network server as defined in claim 18 wherein the server receives information from at least one persistent remote-access VPN client device.

20. A VPN centralized network server as defined in claim 18 wherein the server receives information from at least one transient remote-access VPN client device.

21. A VPN centralized network service as defined in claim 18 wherein the report generating element is capable of producing aggregate information associated with the plurality of separately located remote-access VPN client devices.
